(19) United States
(12) Patent Application Publication
(10) Pub. No.: US 2012/0090906 A1
(43) Pub. Date: Apr. 19, 2012

(54) VENTILATION ASSEMBLY FOR A FRONT EXTERIOR OF A VEHICLE

(75) Inventors: SCOTT P. CHARNESKY, Birmingham, MI (US); DARREN L. BOHNE, Fraser, MI (US); THOMAS K. LOCKWOOD, Fenton, MI (US); MICHAEL G. LEFFERT, Howell, MI (US)

(73) Assignee: GM GLOBAL TECHNOLOGY OPERATIONS, INC., Detroit, MI (US)

(21) Appl. No.: 12/904,191

(22) Filed: Oct. 14, 2010

(51) Int. Cl. B60K 11/00; F01P 3/00

(52) U.S. Cl. 180/68.1; 123/41.04

(57) ABSTRACT

A ventilation assembly is configured for operative attachment to a front exterior of a vehicle. The ventilation assembly includes a first and a second section. The first and second sections are configured to move between respective open and closed positions. The first and second sections define respective first and second openings when the first and second sections are in the respective open positions to provide continuous fluid movement from the front exterior of the vehicle therethrough. Likewise, the first and/or second sections are a fluid barrier, configured to prevent the ingress of fluid from the exterior of the vehicle through the respective opening, when the section is in the respective closed position. Additionally, one of the first and second sections is disposed above the other of the first and second sections on the front exterior of the vehicle.

### TECHNICAL FIELD

The present invention relates to a ventilation assembly configured for operative attachment to a front exterior of a vehicle.

### BACKGROUND OF THE INVENTION

A typical vehicle includes a front end having a grille and a fascia. The grille and the fascia each define at least one opening that is configured for providing a continuous flow of air, to the engine compartment. The continuous flow of air through these openings provides cooling to the engine and engine compartment while operating the vehicle.

### SUMMARY OF THE INVENTION

A ventilation assembly is configured for operative attachment to a front exterior of a vehicle. The ventilation assembly includes a first section and a second section. The first section is configured to move between a first open position and a first closed position. The first section defines at least one first opening when the first section is in the first open position to provide continuous fluid movement from the front exterior of the vehicle through the at least one first opening. The first section is a fluid barrier configured to prevent the ingress of fluid from the exterior of the vehicle through the at least one first opening when the first section is in the first closed position. The second section is configured to move between a second open position and a second closed position. The second section defines at least one second opening when the second section is in the second open position to provide continuous fluid movement from the exterior of the vehicle through the at least one second opening. The second section is a fluid barrier that is configured to prevent the ingress of fluid from the exterior of the vehicle through the at least one second opening when the second section is in the second closed position. The first section is configured to move between the first open and closed positions independent of moving the second section between the second open and closed positions.

Disclosed herein is a method of controlling the flow of air through a ventilation assembly disposed at a front exterior of a vehicle that includes moving a first section between a first open position and a first closed position. The first section defines at least one first opening when the first section is in the first open position to provide continuous fluid movement from the front exterior of the vehicle through the at least one first opening. The first section is a fluid barrier that is configured to prevent the ingress of fluid from the exterior of the vehicle through the at least one first opening when the first section is in the first closed position. A second section is moved between a second open position and a second closed position. The second section defines at least one second opening when the second section is in the second open position to provide continuous fluid movement from the exterior of the vehicle through the at least one second opening. The second section is a fluid barrier that is configured to prevent the ingress of fluid from the exterior of the vehicle through the at least one second opening when the second section is in the second closed position. The first section is configured to move between the first open and closed positions independent of moving the second section between the second open and closed positions.

A vehicle is also provided that includes a front exterior, in the direction of travel, and a ventilation assembly. The ventilation assembly is operatively attached to the front exterior end of the vehicle. The ventilation assembly includes a first section and a second section. The first section is configured to move between a first open position and a first closed position. The first section defines at least one first opening when the first section is in the first open position. The at least one first opening provides continuous fluid movement from the front exterior of the vehicle through the at least one first opening. The first section is a fluid barrier that is configured to prevent the ingress of fluid from the exterior of the vehicle through the at least one first opening when the first section is in the first closed position. The second section is configured to move between a second open position and a second closed position. The second section defines at least one second opening when the second section is in the second open position. The at least one second opening provides continuous fluid movement from the exterior of the vehicle through the at least one second opening. The second section is a fluid barrier that is configured to prevent the ingress of fluid from the exterior of the vehicle through the at least one second opening when the second section is in the second closed position. The first section is configured to move between the first open and closed positions independent of moving the second section between the second open and closed positions.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic top perspective view of a front exterior of a vehicle having a grille and a fascia configured for housing a ventilation assembly;

FIG. 2 is a schematic top exploded perspective view of the grille and the fascia of the vehicle with a blocker removed from the ventilation assembly;

FIG. 3 is a schematic illustration of a partial cross-sectional side view of the vehicle showing first, second, and third sections of the ventilation assembly with the first and second sections in a closed position, where the first section is vertically disposed above the third section;

FIG. 4 is a schematic illustration of the ventilation assembly of FIG. 3 with the first and second sections in an open position;

FIG. 5 is a schematic illustration of a partial cross-sectional side view of the vehicle showing the first, second, and third sections of the ventilation assembly, with the first and second sections in the closed position, where the third section is vertically disposed above the first section; and

FIG. 6 is a schematic illustration of the ventilation assembly of FIG. 5 with the first and second sections in the open position.

### DESCRIPTION OF THE PREFERRED EMBODIMENTS

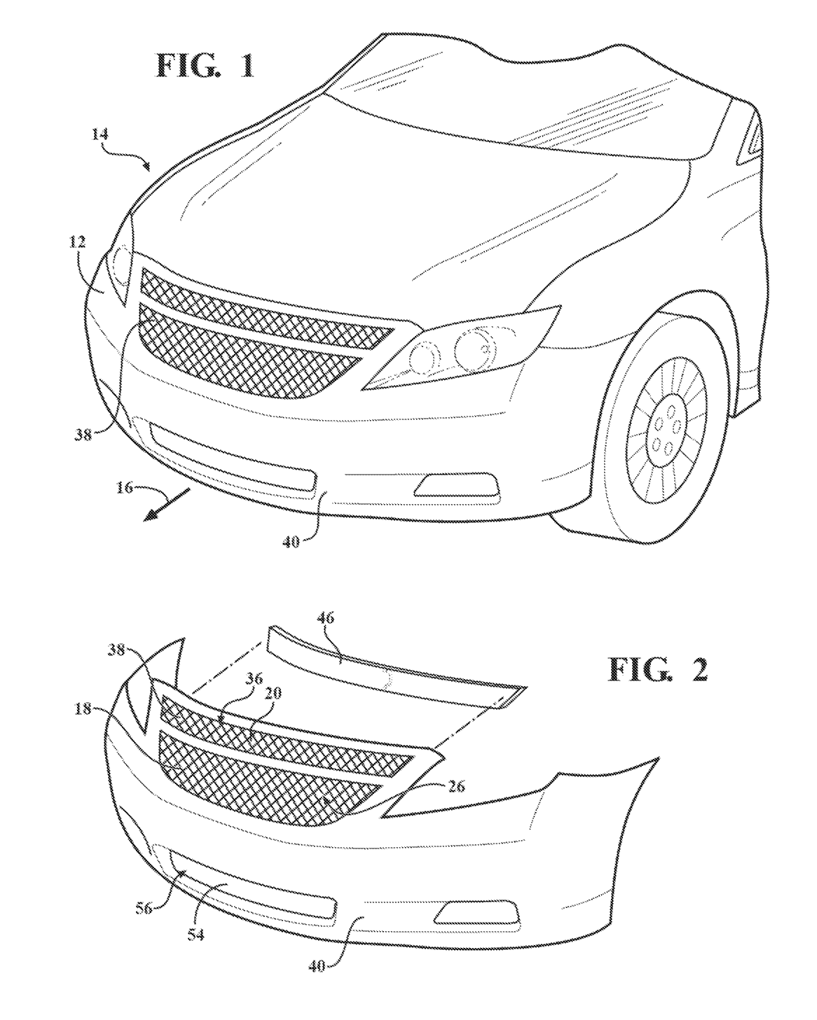

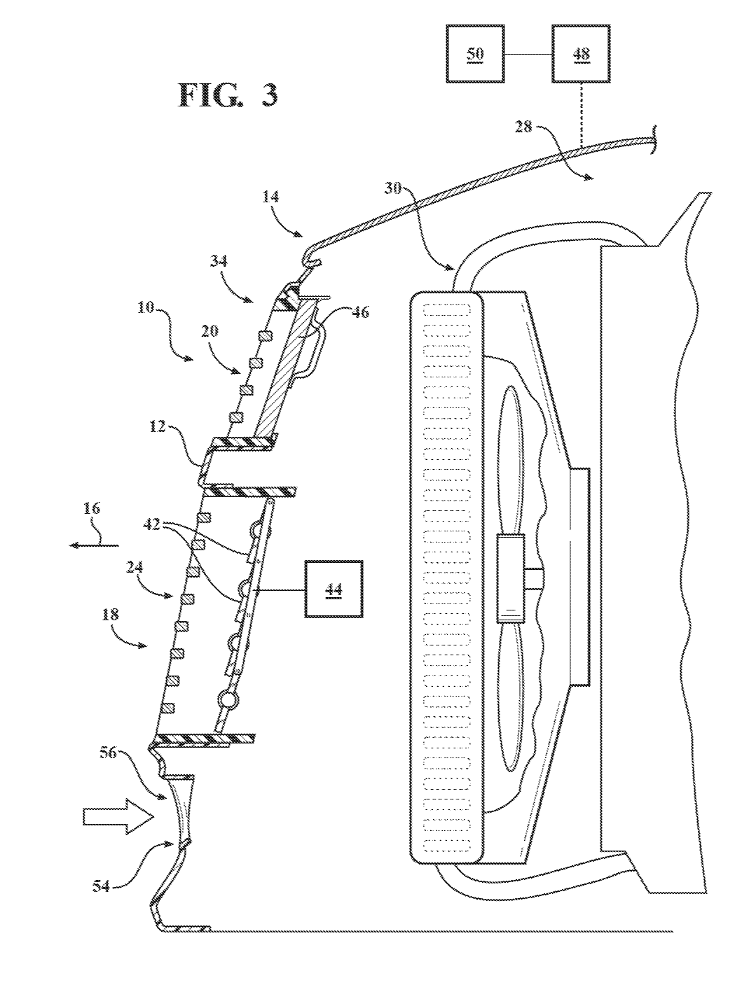

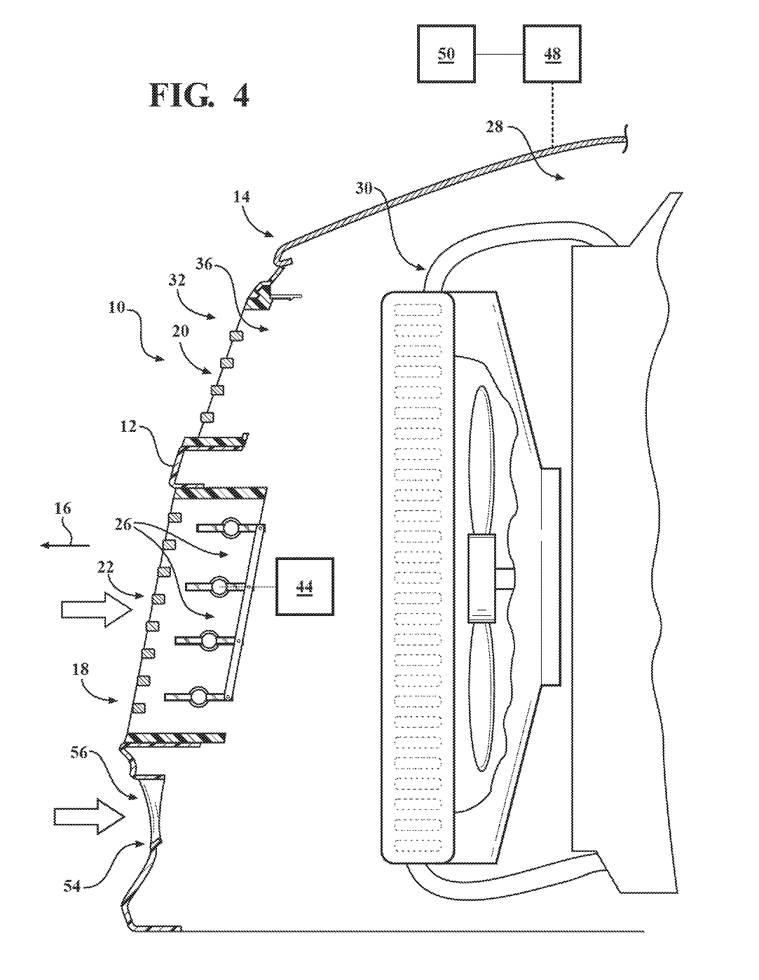

Referring to the drawings, wherein like reference numbers correspond to like or similar components throughout the several figures, FIG. 1 shows a ventilation assembly 10 operatively attached to a front exterior 12 of a vehicle 14, relative to a direction of travel 16. The ventilation assembly 10 includes a first section 18 and a second section 20. The first section 18 is configured to move between a first open position 22, as shown in FIG. 4, and a first closed position 24, as shown in FIG. 3. Referring to FIG. 4, the first section 18 defines at least one first opening 26 when the first section 18 is in the first open position 22. The first opening 26 provides continuous fluid movement from the front exterior 12 of the vehicle 14 through the first opening 26 to an engine compartment 28. More specifically, the fluid may flow through the first opening 26 to provide fluid flow to a cooling system 30, or any other component in the engine compartment 28 that requires fluid flow. Alternatively, referring to FIG. 3, there are times during vehicle 14 operation when fluid flow to the engine compartment 28, through the first opening 26, is not required. When this is the case, the first section 18 is selectively moved to the first closed position 24 such that the first section 18 is now a fluid barrier that is configured to prevent the ingress of fluid from the exterior of the vehicle 14, through the first opening 26. By preventing fluid from flowing through the first opening 26, when fluid is not required, drag on the front exterior 12 of the vehicle 14 is reduced, and fuel economy of the vehicle 14 is improved.

The first section 18 may include any type of covering 42 suitable for covering 42 or closing off the first opening 26 such as, louvers, blocker, shutters, and the like, so long as the covering 42 is movable relative to the first opening 26. The covering 42 may be operatively attached to a first actuator 44 such that the covering 42 moves to cover or uncover the first opening 26 in response to actuation of the actuator.

The second section 20 is configured to move between a second open position 32, as shown in FIG. 4, and a second closed position 34, as shown in FIG. 3. Referring to FIG. 4, the second section 20 defines at least one second opening 36 when the second section 20 is in the second open position 32. The second opening 36 provides continuous fluid movement from the front exterior 12 of the vehicle 14 through the second opening 36 to the engine compartment 28. More specifically, the fluid may flow through the second opening 36 to also provide fluid flow to the cooling system 30, or any other component that require fluid flow. Referring again to FIG. 3, there are times during vehicle 14 operation when fluid flow to the engine compartment 28, through the second opening 36, is not required. When this is the case, the second section 20 is moved to the second closed position 34 such that the second section 20 becomes a fluid barrier that is configured to prevent the ingress of fluid from the front exterior 12 of the vehicle 14 through the second opening 36. By preventing fluid from flowing through the second opening 36, drag on the front exterior 12 of the vehicle 14 is reduced, and fuel economy of the vehicle 14 is improved.

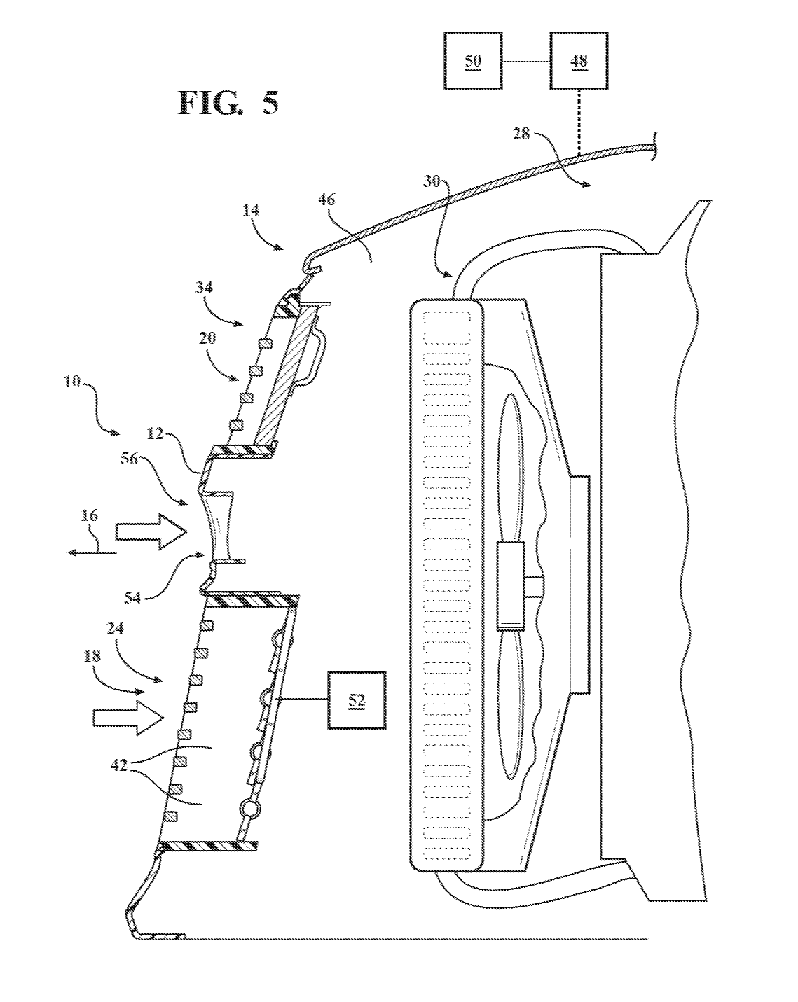

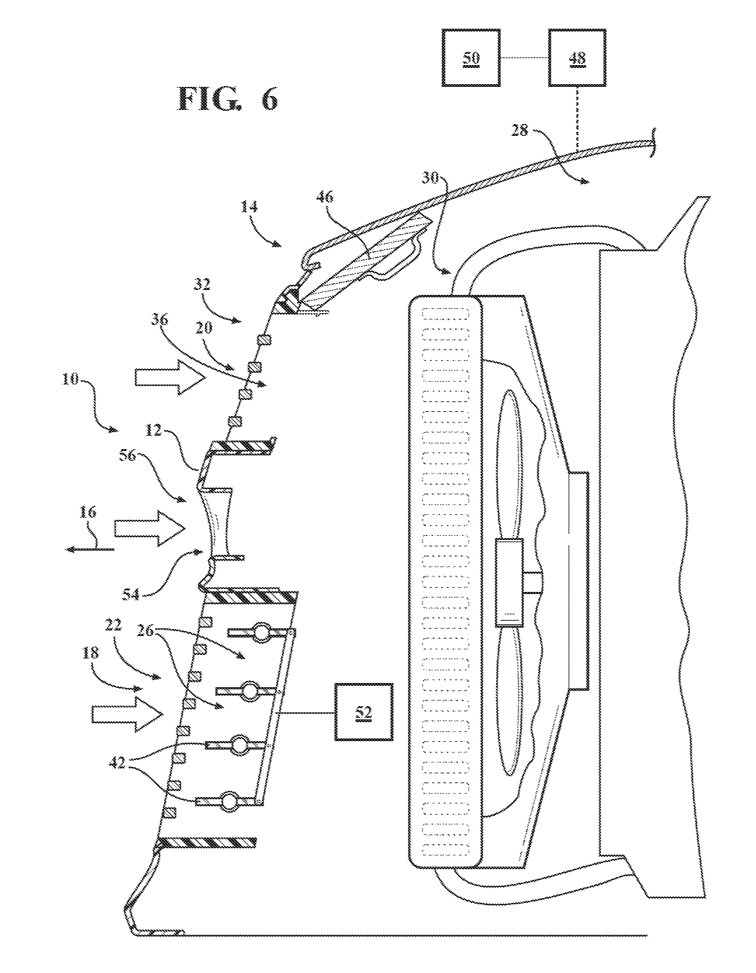

Referring to FIGS. 4 and 5, the first and second sections 18, 20 are vertically disposed above one another on the front exterior 12 of the vehicle 14. The first and second sections 18, 20 are generally centered and may be formed as part of a grille 38 and/or a fascia 40. In the embodiments described in FIGS. 4 and 5, the first section 18 is vertically disposed below the second section 20. It should be appreciated, however, that the second section 20 may be vertically disposed above the first section 18, as shown in FIGS. 5 and 6. As will be described in more detail below, the first and second sections 18, 20 are configured to provide on-demand cooling to the cooling system 30 and/or engine components (not shown).

Referring to FIGS. 4-6, the second section 20 includes a blocker 46 that is configured to be removably disposed in the second opening 36. When the blocker 46 is disposed in the second opening 36, the blocker 46 covers the second opening 36 to prevent the ingress of fluid from the front exterior 12 of the vehicle 14 through the second opening 36. A sensor 48 may be operatively attached to the second section 20 to detect when the blocker 46 is covering 42 the second opening 36.

The first section 18 is configured to move between the first open and closed positions 22, 24, independent of the second section 20 moving between the second open and closed positions 32, 34. Therefore, the first section 18 may be in the first open position 22 while the second section 20 is in the second closed position 34, or vice versa. The first section 18 is configured to move to the first open position 22 in response to an operating characteristic of the vehicle 14 being at least equal to a first threshold. Likewise, the first section 18 is configured to move to the first closed position 24 in response to the operating characteristic of the vehicle 14 being less than the first threshold.

The ability to selectively and independently move the first and second sections 18, 20 between the respective open positions 22, 32, shown in FIG. 4, and closed positions 24, 34, as shown in FIG. 3, allows for on-demand cooling of the cooling system 30 and/or engine components, as required during vehicle 14 operation. The fewer the openings defined in the front exterior 12 of the vehicle 14, the less drag on the vehicle 14. The lower the drag on the vehicle 14, the greater the fuel economy. Therefore, the first and second sections 18, 20 are configured to be selectively and independently moved between the first and second open and closed positions 22, 32, 24, 34 based on demands of the components in the engine compartment 28. In order to determine the required position of the first section 18, one or more operating characteristics of the vehicle 14 are determined, i.e., speed of the vehicle 14, the engine load, engine oil temperature, and the like. The first section 18 is moved to either the first open or first closed position 22, 24 in response to the determined operating characteristic of the vehicle 14. As discussed above, the first section 18 is moved to the first open position 22 in response to the determined operating characteristic of the vehicle 14 being at least equal to the first threshold.

Likewise, in order to determine the required position of the second section 20, the operating characteristic of the vehicle 14 may be determined and the second section 20 is moved to either the second open or the second closed position 32, 34 in response to the determined operating characteristics of the vehicle 14. The second section 20 is moved to the second open position 32 in response to the operating characteristic of the vehicle 14 being at least equal to the second threshold. Additionally, the first section 18 is moved between the first open and closed positions independent of moving the second section 20 between the second open and closed positions 32, 34. This allows for better control of the cooling of the radiator and/or engine components, while improving fuel economy.

The second open position 32 of the second section 20 may be achieved by removing the blocker 46 from obstructing the second opening 36. Removing the blocker 46 allows the ingress of fluid from the exterior of the vehicle 14 through the second opening 36. The blocker 46 may be removed by the vehicle operator prior to use, such as when hauling heavy loads, i.e., boats, RVs, and the like. Likewise, the second closed position 34 is achieved by disposing the blocker 46 such that the second opening 36 is obstructed by the blocker 46. This obstruction prevents the ingress of fluid from the exterior of the vehicle 14 through the second opening 36. The sensor 48 may be operatively connected to the second section 20 in order to detect the position of the blocker 46 relative to the second opening 36. More specifically, the sensor 48 is configured to detect whether the blocker 46 is obstructing the second opening 36, i.e., the second section 20 is in the second closed position 34, or that the blocker 46 is not obstructing the second opening 36, i.e., the second section 20 is in the second open position 32. Other sensors 48 may be operatively connected to the vehicle 14 and are configured to detect the various operating characteristics of the vehicle 14, such as engine temperature, engine speed, vehicle speed, and the like. A controller 50 may be operatively connected to the vehicle 14 and configured to transmit a signal to alert the vehicle operator when the blocker 46 is detected to be obstructing the second opening 36 and when at least one of the operating characteristics of the vehicle 14 is at least equal to the second threshold. The signal alerts the operator to remove the blocker 46 from the second opening 36 before continuing with operation of the vehicle 14.

Alternatively, referring to the embodiment in FIGS. 5 and 6, the blocker 46 may be configured to be automatically removed from obstructing the second opening 36 in response to the controller 50. More specifically, a second actuator 52 may be operatively connected to the blocker 46. The controller 50 may be configured to transmit the signal to actuate the second actuator 52 to move the blocker 46 to move to the requisite second open position 32, as shown in FIG. 6, or the second closed position 34, as shown in FIG. 5, based on the operating characteristic of the vehicle 14.

Additionally, referring to FIGS. 3-6, a third section 54 may be provided. The third section 54 defines a third opening 56 that is configured to provide continuous fluid movement from the front exterior 12 of the vehicle 14 through the third opening 56. The third section 54 is configured such that the third opening 56 remains continuously open. Therefore, even if the first and second openings 26, 36 are in the respective first and second closed positions 24, 34, the third opening 56 remains open. To provide cooling to the engine compartment 28, the third section 54 is vertically disposed below at least one of the first and second sections 18, 20. Referring to FIG. 2, the third section 54 is vertically disposed below each of the first and second sections 18, 20. It should be appreciated that the third section 54 may also be disposed in any other desired location, relative to the first and second sections 18, 20.

While the best modes for carrying out the invention have been described in detail, those familiar with the art to which this invention relates will recognize various alternative designs and embodiments for practicing the invention within the scope of the appended claims.

1. A ventilation assembly configured for operative attachment to a front exterior of a vehicle, the ventilation assembly comprising:
a first section configured to move between a first open position and a first closed position;
wherein the first section defines at least one first opening when the first section is in the first open position to provide continuous fluid movement from the front exterior of the vehicle through the at least one first opening;
wherein the first section is a fluid barrier configured to prevent the ingress of fluid from the exterior of the vehicle through the at least one first opening when the first section is in the first closed position; and
a second section configured to move between a second open position and a second closed position;
wherein the second section defines at least one second opening when the second section is in the second open position to provide continuous fluid movement from the exterior of the vehicle through the at least one second opening;
wherein the second section is a fluid barrier configured to prevent the ingress of fluid from the exterior of the vehicle through the at least one second opening when the second section is in the second closed position; and
wherein the first section is configured to move between the first open and first closed positions independent of the second section moving between the second open and second closed positions.

2. A ventilation assembly, as set forth in claim 1, wherein the first section is configured to move to the first open position in response to a vehicle speed at least equal to a first threshold; and
wherein the first section is configured to move to the first closed position in response to the vehicle speed of less than the first threshold.

3. A ventilation assembly, as set forth in claim 1, wherein one of the first and second sections is disposed above the other of the first and second sections.

4. A ventilation assembly, as set forth in claim 1, wherein the second section includes a blocker configured to be removably disposed in the second opening such that the blocker covers the second opening to prevent the ingress of fluid from the exterior of the vehicle through the at least one second opening.

5. A ventilation assembly, as set forth in claim 4, further comprising a sensor operatively connected to the second section and configured to detect when the blocker covers the second opening.

6. A variable opening, as set forth in claim 1, further comprising a third section defining a third opening configured to provide continuous fluid movement from the exterior of the vehicle through the at least one third opening.

7. A ventilation assembly, as set forth in claim 6, wherein the third section is configured such that the third opening remains continuously open.

8. A ventilation assembly, as set forth in claim 6, wherein the third section is disposed below at least one of the first and second sections.

9. A method of controlling the flow of air through a ventilation assembly disposed at a front exterior of a vehicle, the method comprising:
moving a first section between a first open position and a first closed position;
wherein the first section defines at least one first opening when the first section is in the first open position to provide continuous fluid movement from the front exterior of the vehicle through the at least one first opening;
wherein the first section is a fluid barrier configured to prevent the ingress of fluid from the exterior of the vehicle through the at least one first opening when the first section is in the first closed position; and
moving a second section between a second open position and a second closed position;
wherein the second section defines at least one second opening when the second section is in the second open position to provide continuous fluid movement from the exterior of the vehicle through the at least one second opening;
wherein the second section is a fluid barrier configured to prevent the ingress of fluid from the exterior of the vehicle through the at least one second opening when the second section is in the second closed position; and
wherein the first section is moved between the first open and closed positions independent of moving the second section between the second open and closed positions.

10. A method, as set forth in claim 10, further comprising:
determining a operating characteristic of the vehicle; and
moving the first section to one of a first open position and a first closed position in response to the determined operating characteristic of the vehicle;
wherein the first section is moved to the first open position in response to the determined operating characteristic of the vehicle being at least equal to a first threshold; and
wherein the first section is moved to the first closed position in response to the determined operating characteristic of the vehicle being less than the first threshold

11. A method, as set forth in claim 10, wherein one of the first and second sections is disposed above the other of the first and second sections.

12. A method, as set forth in claim 10, wherein moving a second section between a second open position and a second closed position is further defined as:
removing a blocker from obstructing the second opening to allow ingress of fluid from the exterior of the vehicle through the at least one second opening; and
disposing a blocker to obstruct the second opening and prevent the ingress of fluid from the exterior of the vehicle through the at least one second opening.

13. A method, as set forth in claim 12, further comprising:
detecting the position of the blocker relative to the second opening;
detecting at least one operating characteristic of the vehicle; and
transmitting a signal when the blocker is detected to be obstructing the second opening and the at least one operating characteristic of the vehicle is determined to be at least equal to a second threshold.

14. A vehicle comprising:
a front exterior, in the direction of travel; and
a ventilation assembly operatively attached to the front exterior of the vehicle, the ventilation assembly including:
a first section configured to move between a first open position and a first closed position;
wherein the first section defines at least one first opening when the first section is in the first open position to provide continuous fluid movement from the front exterior of the vehicle through the at least one first opening;
wherein the first section is a fluid barrier configured to prevent the ingress of fluid from the exterior of the vehicle through the at least one first opening when the first section is in the first closed position; and
a second section configured to move between a second open position and a second closed position;
wherein the second section defines at least one second opening when the second section is in the second open position to provide continuous fluid movement from the exterior of the vehicle through the at least one second opening;
wherein the second section is a fluid barrier configured to prevent the ingress of fluid from the exterior of the vehicle through the at least one second opening when the second section is in the second closed position; and
wherein the first section is moved between the first open and closed positions independent of moving the second section between the second open and closed positions.

15. A vehicle, as set forth in claim 14, wherein the first section is configured to automatically move to the first open position in response to an operating characteristic of the vehicle being at least equal to a first threshold; and
wherein the first section is configured to automatically move to the first closed position in response to the vehicle speed of less than the first threshold.

16. A vehicle, as set forth in claim 14, further comprising a sensor operatively connected to the second section and configured to detect when the second section is in the second closed position.

17. A vehicle, as set forth in claim 14, further comprising a controller configured to transmit a signal when the second opening is detected to be in the second closed position and when the at least one operating characteristic of the vehicle is at least equal to a second threshold.

18. A vehicle, as set forth in claim 14, further comprising a third section defining a third opening configured to provide continuous fluid movement from the exterior of the vehicle through the at least one third opening.

19. A vehicle, as set forth in claim 14, wherein one of the first and second sections is disposed above the other of the first and second sections.
